(19) United States
(12) Patent Application Publication
(10) Pub. No.: US 2021/0037614 A1
(43) Pub. Date: Feb. 4, 2021

(54) Film Heater

(71) Applicant: TOPPAN INFOMEDIA, CO., LTD., Minato-ku (JP)

(72) Inventor: Tatsuya OTSUKA, Sagamihara-shi (JP)

(21) Appl. No.: 17/041,890

(22) PCT Filed: Mar. 19, 2019
(86) PCT No.: PCT/JP2019/011399

§ 371 Date: Sep. 25, 2020

(30) Foreign Application Priority Data
Mar. 26, 2018 (JP) 2018-057763
Mar. 26, 2018 (JP) 2018-057764

(51) Int. Cl. H05B 3/36; H05B 3/06

(52) U.S. Cl. CPC H05B 3/36; H05B 3/06

(57) ABSTRACT

Provided is a film heater which is easy to manufacture and is capable of being easily adhesively attached to an adherend even having an uneven shape, without impairing aesthetic quality of the adherend. In the film heater, a conductive pattern composed of a conductive wire is provided on one surface of a support sheet composed of a transparent thermoplastic resin sheet, wherein the conductive pattern is configured such that a connection terminal section, a lead wire extending from the connection terminal section and a heater section continuing from the lead wire are provided as a continuous linear pattern composed of a single conductive wire.

### TECHNICAL FIELD

The present invention relates to a film heater, and more particularly to a film heater in which a conductor pattern electrically connectable to an external power source is provided on a film.

### BACKGROUND ART

Heretofore, there has been known a film-shaped planar heating element having an electroconductive (conductive) pattern for heating, to be used in a state in which it is adhesively attached to an adherend which is subject to heating, for the purpose of anti-ice/snow adhesion, snow melting, anti-fogging, heat-retention, etc.

For example, in the following Patent Document 1, there is disclosed a planar heating element in which a bare nichrome wire processed into an arbitrary shape is disposed inside two multi-layer composite films though an adhesive layer composed of an insulating material, wherein it is described that this planar heating element is adhesively attached to a to-be-heated object by a two-sided pressure-sensitive adhesive tape, a two-sided pressure-sensitive adhesive film or the like. In the following Patent Document 2, there is disclosed a hard planar heating element-producing semi-cured sheet which comprises a planar heat generation part having flexibility, and a semi-cured resin covering layer formed in a semi-cured state to envelop the heat generation part. There, it is described that the semi-cured resin covering layer enveloping the heat generation part is in a semi-cured state (B-stage), wherein it has flexibility and plasticity, and the surface thereof has a pressure-sensitive adhesive property, whereby the covering layer can follow the shape of any adherend, thereby allowing the sheet to be adhesively attached to the adherend.

In the following Patent Document 3, there is disclosed a planar heater for a traffic light, which is characterized in that a metal wire resistive element formed in a given pattern is provided on the surface of or inside a circular sheet-shaped flexible transparent substrate having a circular sector-shaped cutout with a central angle of 90 degrees or less, wherein it is described that, even when an indication window of the traffic light has a dome shape, it is possible to easily ensure close contact with the heater by bringing straight portions of the circular sector-shaped cutout into contact with or close to each other to deform the flexible transparent substrate from a circular sheet to a conical shape.

### CITATION LIST

### Parent Document

Patent Document 1: JP 2003-257597A

Patent Document 2: JP 2006-278138A

Patent Document 3: JP 2017-004918A

### SUMMARY OF INVENTION

### Technical Problem

In the invention disclosed in the Patent Document 1, the bare nichrome wire is disposed inside the two multi-layer composite films by using the adhesive layer for fixing the wire, and respective peripheries of the multi-layer composite films are heat-sealed together, which leads to complicated configuration.

Moreover, in the case where a planar heating element is adhesively attached to an adherent by using a two-sided pressure-sensitive adhesive tape or a two-sided pressure-sensitive adhesive film, as in the invention disclosed in the Patent Document 1, air bubbles are likely to be contained between the planar heating element and the adherend, causing impairment of external appearance and breakage or the like.

The invention disclosed in the Patent Document 2 requires using a particular resin covering film, and requires particular equipment for fully curing the semi-cured resin covering layer by a photo-curing method, so that a forming method is likely to become complicated.

The invention disclosed in the Patent Document 3 is effective in the case where the indication window of the traffic light has a dome shape, but is hard to use in other cases.

It is an object of the present invention to provide a film heater which is easy to manufacture and is capable of being readily adhesively attached to an adherend even having an uneven shape, without impairing aesthetic quality of the adherend.

It is another object of the present invention to provide a film heater which is capable of being readily adhesively attached to an adherend which is subject to heating, even when the adherend has an uneven shape, without impairing aesthetic quality of the adherend, and with a low risk of containing air bubbles causing bad external appearance and breakage or the like, and has good formability, high mechanical strength, and excellent adhesiveness with respect to the adherend.

### Solution to Technical Problem

According to a first aspect of the present invention, there is provided a film heater comprising a conductive pattern composed of a conductive wire, the conductive pattern is provided on one surface of a support sheet composed of a transparent thermoplastic resin sheet, wherein the conductive pattern is configured such that a connection terminal section, a lead wire extending from the connection terminal section and a heater section continuing from the lead wire are provided as a continuous linear pattern composed of a single conductive wire.

Preferably, in the film heater according to the first aspect of the present invention, the connection terminal section is configured to have a pattern in which the conductive wire is folded back at a plurality of positions, e.g., to have a meander shape in which the conductive wire extends in a meandering manner while being folded back at a plurality of positions.

In the film heater according to the first aspect of the present invention, an outer layer sheet composed of a transparent thermoplastic resin sheet other than the support sheet may be provided on the surface of the support sheet provided with the conductive pattern, to cover the conductive pattern, wherein the outer layer sheet may be provided with a through-hole which allows at least a part of the connection terminal section to be exposed to outside.

In the film heater according to the first aspect of the present invention, a metal plate may be further provided on the connection terminal section.

Preferably, in the film heater according to the first aspect of the present invention, the conductive wire composing the conductive pattern, except for the connection terminal section, is coated with an insulating film having a self-fusing property.

In the film heater according to the first aspect of the present invention, a pressure-sensitive adhesive layer may be provided on a surface of the support sheet on a side opposite to the surface provided with the conductive pattern.

According to a second aspect of the present invention, there is provided a film heater comprising a conductive pattern composed of a conductive wire, the conductive pattern is provided on one of opposite surfaces of a support sheet composed of a transparent thermoplastic resin sheet, wherein the other surface of the support sheet has unevenness, and the conductive pattern comprises a connection terminal section, a lead wire extending from the connection terminal section, and a heater section continuing from the lead wire.

Preferably, in the film heater according to the second aspect of the present invention, the conductive pattern is formed of a continuous single conductive wire.

Preferably, in the film heater according to the second aspect of the present invention, the connection terminal section is configured to have a pattern in which the conductive wire is folded back at a plurality of positions, e.g., to have a meander shape in which the conductive wire extends in a meandering manner while being folded back at a plurality of positions.

Preferably, in the film heater according to the second aspect of the present invention, an outer layer sheet composed of a transparent thermoplastic resin sheet other than the support sheet is provided on the one surface of the support sheet, to cover the conductive pattern, wherein the outer layer sheet is provided with a through-hole which allows at least a part of the connection terminal section to be exposed to outside.

In the film heater according to the second aspect of the present invention, a metal plate may be further provided on the connection terminal section.

Preferably, in the film heater according to the second aspect of the present invention, the conductive wire composing the conductive pattern, except for the connection terminal section, is coated with an insulating film having a self-fusing property.

In the film heater according to the second aspect of the present invention, a pressure-sensitive adhesive layer may be provided on the other surface of the support sheet having unevenness.

### Effect of Invention

The film heater according to the first aspect of the present invention is transparent in whole, and is capable of being adhesively attached to any of various adherends which are subject to heating, without impairing aesthetic quality of the adherend. Further, by using a thermoplastic resin sheet as the support sheet, and, if present, the outer layer sheet, it becomes possible to readily adhesively attach the film heater to an adherend even having an uneven shape. In particular, when the adherend is a resin molded body, the film heater can be in-mold transferred so as to be formed in the surface of the resin molded body, concurrently with molding. Further, the conductive pattern is composed of a single conductive wire. Thus, the conductive pattern can be continuously formed by the single conductive wire, thereby facilitating manufacturing. In addition, the entire surface of the support sheet formed with the conductive pattern may be covered by the outer layer sheet. This makes it possible to protect the conductive pattern.

The film heater according to the second aspect of the present invention is transparent in whole, and is capable of being adhesively attached to any of various adherends which are subject to heating, without impairing aesthetic quality of the adherend. Further, the other surface of the support sheet to be laminated to the adherend is formed as an uneven surface. Thus, escaping of air during lamination to the adherend becomes better, so that air bubbles causing bad external appearance and breakage or the like become less likely to be contained therebetween.

By using a thermoplastic resin sheet as the support sheet, and, if present, the outer layer sheet, it becomes possible to readily adhesively attach the film heater to an adherend even having an uneven shape, and can be in-mold transferred.

The conductive pattern is continuously formed by the single conductive wire, so that it becomes possible to facilitate manufacturing. Further, the entire surface of the support sheet formed with the conductive pattern may be covered by the outer layer sheet. This makes it possible to protect the conductive pattern.

The present invention provides a film heater having good formability, high mechanical strength, and excellent adhesiveness with respect to an adherend, and applicable to various applications for the purpose of anti-ice/snow adhesion, snow melting, anti-fogging, heat-retention, etc., such as a headlight of an automobile, a grip or seat of a motorcycle, an outside light, and traffic light.

### BRIEF DESCRIPTION OF DRAWINGS

FIG. 1(a) and FIG. 1(b) are, respectively, a top plan view and a sectional view each schematically showing one example of a film heater according to a first aspect of the present invention.

FIG. 2(a) and FIG. 2(b) are, respectively, a top plan view and a sectional view each schematically showing one example of an outer layer sheet usable in the film heater according to the first aspect of the present invention,

FIG. 3(a) and FIG. 3(b) are, respectively, a top plan view and a sectional view each schematically showing one example of the film heater according to the first aspect of the present invention, using the outer layer sheet.

FIG. 4(a) and FIG. 4(b) are, respectively, a top plan view and a sectional view each schematically showing one example of a film heater according to a second aspect of the present invention.

FIG. 5(a) and FIG. 5(b) are, respectively, a top plan view and a sectional view each schematically showing one example of an outer layer sheet usable in the film heater according to the second aspect of the present invention.

FIG. 6(a) and FIG. 6(b) are, respectively, a top plan view and a sectional view each schematically showing one example of the film heater according to the second aspect of the present invention, using the outer layer sheet.

### DESCRIPTION OF EMBODIMENTS

With reference to the drawings, the present invention will now be described based on some embodiments thereof.

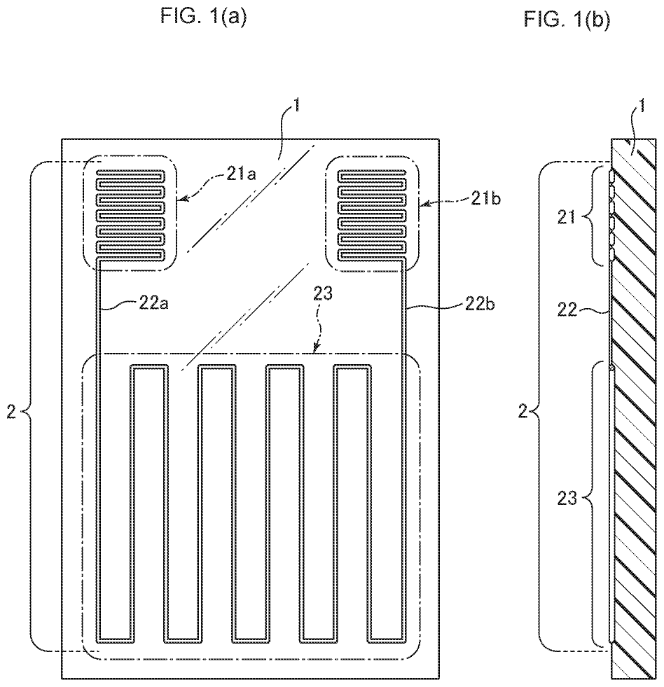

FIG. 1(a) is a top plan view schematically showing one example of a film heater according to a first aspect of the present invention. FIG. 1(b) is a sectional view schematically showing the one example of the film heater according to the first aspect of the present invention.

Referring to FIG. 1, a conductive pattern 2 composed of a conductive wire is provided on one of opposite surfaces of a support sheet 1 composed of a transparent thermoplastic resin sheet. The conductive pattern 2 is configured such that a pair of right and left connection terminal sections 21a, 21b, a pair of right and left lead wires 22a, 22b each extending from a respective one of the connection terminal sections 21a, 21b, and a heater section 23 continuing from the lead wires 22a, 22b, are provided as a continuous linear pattern composed of a single conductive wire. As in this embodiment, the heater section may be formed in a wholly non-straight linear shape.

The support sheet to be used in the film heater according to the first aspect of the present invention is composed of a transparent thermoplastic resin sheet. This makes it possible to suitably produce a wholly transparent film heater. Such a wholly transparent film heater can be adhesively attached to any of various adherends which are subjected to heating, without impairing aesthetic quality of the adherend.

Further, by using a thermoplastic resin sheet, it becomes possible to readily adhesively attach the film heater to an adherend even having an uneven shape. In particular, when the adherend is a resin molded body, the film heater can be formed in the surface of the resin molded body, by a molding process, such as vacuum molding, hot press molding, laminate molding, in-mold molding, or insert molding.

As the thermoplastic resin sheet, it is possible to use ethylene-based resin, propylene-based resin, polyolefin-based resin, thermoplastic polyester-based resin, polyamide-based resin, polyvinyl chloride, polycarbonate, ABS resin or the like. A mixture containing two or more of these resins may also be used. In particular, it is preferable to use polypropylene-based resin which is excellent in terms of formability (moldability), mechanical strength, flexibility, and weather resistance.

It is possible to appropriately add, to the thermoplastic resin sheet, an inorganic fine powder or organic filler, a dispersant, an antioxidant, a compatibilizing agent, an ultraviolet light stabilizer, an anti-blocking agent, an antistatic agent, and the like.

The thickness of the thermoplastic resin sheet is preferably 0.030 mm to 1.000 mm, more preferably 0.100 mm to 0.700 mm.

The conductive pattern 2 can be formed by printing using conductive ink such as silver paste, or by etching of a metal foil such as copper foil. When forming the conductive pattern, it is preferable to form a cross-sectionally circular conductive wire having a constant diameter, into a given pattern, from a viewpoint of being able to easily form the heater section, the lead sections and the connection terminal sections, as a single continuous linear shape.

In a case where the conductive pattern is composed of a conductive wire, the conductive wire is preferably configured such that it comprises at least a metal wire. More preferably, the metal wire is coated with an insulating film having a self-fusing property. Although it is possible to use, as the metal wire, a wire made of metal such as copper, iron, gold, copper nickel, nickel chrome, or iron nickel chrome, any other material may also be used as long as it has a conductive property. From a viewpoint of electric resistance, durability and cost, it is preferable to use, as the metal wire, copper, or a copper alloy comprising copper, and one or a combination of two or more selected from the group consisting of zinc, lead, tin, silver, aluminum, nickel, beryllium and zirconium.

The insulating film coating the metal wire is an insulating resin film, and the conductive wire coated with the insulating film may be a commercially-available enamel wire. Specific examples of the insulating resin film may include polyester, polyethylene, polyurethane, polyvinyl chloride, polyamide, polyimide, polyester imide, polyamide imide, and fluororesin. The insulation film is typically black. However, the insulating film may be colored with any color, according to the color of an adherend which is subject to heating.

For example, the diameter of the conductive wire composing the conductive pattern is 0.03 mm to 0.20 mm. Although it is not always easy to form a thin conductive wire, the conductive wire is preferably thinned as much as possible in order to prevent impairment of aesthetic quality of an adherend which is subject to heating. Preferably, the diameter of the conductive wire is 0.05 mm to 0.15 mm. The length of the conductive wire may be set according to the pattern configuration of the conductive pattern.

The conductive pattern can be formed, typically, by laying the conductive wire on the support sheet to draw a given pattern configuration, and embedding the conductive wire at least in the surface of the support sheet to fix the conductive wire thereto.

As a method of embedding the conductive wire into the surface of the support sheet, it is desirable to embed the conductive wire in the surface of the support sheet, e.g., by utilizing the principle of ultrasonic fusing. In the ultrasonic fusing, it is possible to use a wiring drawing apparatus capable of melting the surface of the support sheet made of thermoplastic resin, while feeding out a conductive wire, and embedding the conductive wire in the surface of the support sheet. An ultrasonic head equipped in the wiring drawing apparatus is operable to apply vibration and pressure to the conductive wire which is being fed onto the surface of the support sheet, so as to cause the conductive wire to be embedded in the surface of the support sheet.

The embedding of the conductive wire into the surface of the support sheet makes it possible to perform positioning of the conductive pattern on the support sheet, thereby suppressing displacement of the conductive wire due to shock or the like from the outside. Further, by embedding the conductive wire in the surface of the support sheet, it becomes possible to reduce the level of unevenness on the surface of the support sheet caused by disposing the conductive wire on the surface of the support sheet.

Next, one embodiment of the conductive pattern of the film heater according to the first aspect of the present invention will be described.

Referring to FIG. 1, the conductive pattern 2 is configured such that a pair of right and left connection terminal sections 21a, 21b, a pair of right and left lead wires 22a, 22b each extending from a respective one of the connection terminal sections 21a, 21b, and a wholly non-straight heater section 23 continuing from the lead wires 22a, 22b, are provided as a continuous linear pattern composed of a single conductive wire.

By forming the connection terminal sections, the lead wires and the heater section, using a single continuous wire, it becomes possible to simplify a production process and produce a low-cost film heater.

In FIG. 1, each of the connection terminal sections 21a, 21b is formed in a meander shape in which the conductive wire extends in a meandering manner while being folded back at a plurality of positions. In this case, each of the connection terminal sections 21a, 21b is preferably configured such that the number of times of folding-back in a folding-back region where the conductive wire is folded back at a plurality of positions in a meandering manner is increased in a given plane area to densely arrange the resulting folded-back wire portions. In the embodiment illustrated in FIG. 1, the meander shape is suitably set such that a bended portion having a relatively short length and a straight portion having a relatively long length are repeated, wherein the number of the straight portions is set to two/mm or more.

Further, as need arises, a conductive piece composed of a metal plate may be additionally provided on the connection terminal section to raise the efficiency of connection between the connection terminal section and an external electrode. As the metal plate, it is possible to use, e.g., copper, a copper alloy, iron, or an iron-nickel alloy.

In a situation where the conductive wire is coated with an insulating film, the insulating film coating the conductive wire is partly removed in a region corresponding to the the connection terminal sections, to expose the internal metal wire. A way to attain the exposure may include cutting using a milling apparatus. Alternatively, the insulating film may be melted and removed by heat during soldering connection with respect to a metal plate or external electrode.

The heater section 23 is formed by being laid from the lead wires 22a, 22b each extending from a corresponding one of the pair of right and left connection terminal sections 21a, 21b, and formed. In FIG. 1, the heater section 23 is formed as a wholly non-straight linear pattern in which a bended portion having a relatively short length and a straight portion having a relatively long length are repeated, i.e., the conductive wire extends in a meandering manner while being folded back at a plurality of positions. The pattern of the heater section may be set to any pattern, while taking into account the shape, heating area and heating efficiency of an adherent. For example, it may be repetitive of a curved shape including no straight portion, or a spiral shape.

In FIG. 1, the conductive pattern comprises the pair of right and left connection terminal sections 21a, 21b and the pair of right and left lead sections 22a, 22b, centering on the heater section 23, wherein: one 21a of the meander-shaped connection sections is formed of a conductive wire to extend from one end thereof as a starting point; one 22a of the lead wires extends from the other end of this connection section 21a; the heater section 23 is formed of a conductive film laid from this lead wire 22a; and the other lead wire 22b extends from this heater section 23 to the other connection terminal section 21b, whereby the heater section 23, the lead sections 22 and the connection terminal sections 21 are formed as a continuous linear pattern composed of a single conductive wire.

In another embodiment of the first aspect of the present invention, the film heater may be configured such that an outer layer sheet composed of an additional transparent thermoplastic resin sheet is provided on the surface of the support sheet provided with the conductive pattern, to cover the conductive pattern, wherein the outer layer sheet is provided with two through-holes each allowing at least a part of a respective one of the connection terminal sections to be exposed to the outside.

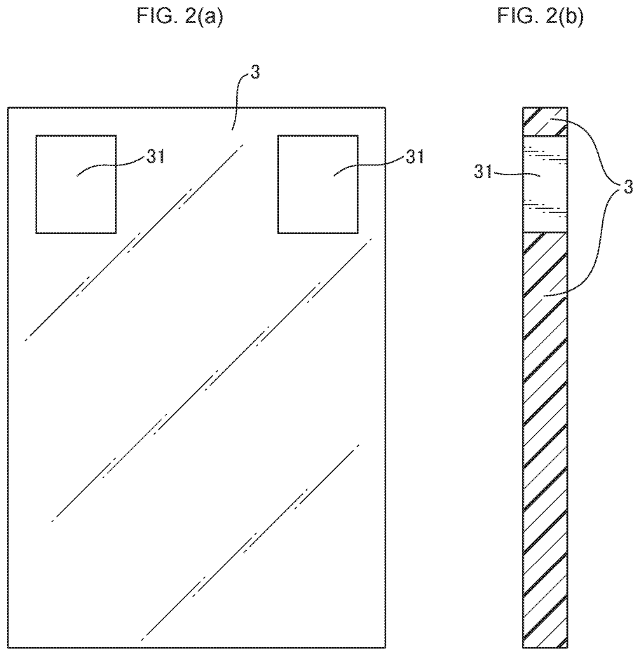

FIG. 2(a) is a top plan view schematically showing one example of an outer layer sheet usable in the first aspect of the present invention. FIG. 2(b) is a sectional view schematically showing the one example of the outer layer sheet usable in the first aspect of the present invention.

In FIG. 2, an outer layer sheet 3 having approximately the same shape as that of the support sheet of the film heater is provided with two through-holes 31 each allowing at least a part of a respective one of the connection terminal sections of the film heater to be exposed to the outside.

The outer layer sheet may be formed using a thermoplastic resin sheet similar to the support sheet. In this case, the outer layer sheet can be laminated to the surface of the support sheet formed with the conductive pattern by subjecting them to heat treatment and/or pressing. During the lamination, an adhesive layer, a pressure-sensitive adhesive layer, a heat-sealing layer or the like may be interposed between the support sheet and the outer layer sheet, as needed basis.

The outer layer sheet is provided with the through-holes each allowing at least a part of a respective one of the connection terminal sections to be exposed to the outside. The through-holes of the outer layer sheet for exposure of the connection terminal section can be formed by means of punching by a die, or cutting means such as a laser apparatus. Specifically, a Thompson blade, a cutting blade, a laser cutter, a milling apparatus or the like may be used.

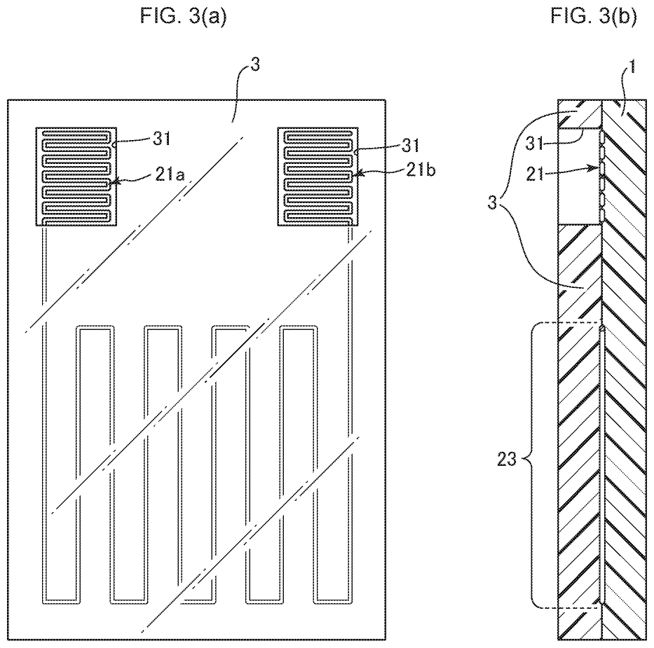

FIG. 3(a) is a top plan view schematically showing one example of the film heater according to the first aspect of the present invention, using the outer layer sheet. FIG. 3(b) is a sectional view schematically showing the one example of the film heater according to the first aspect of the present invention, using the outer layer sheet.

As can be understood from the embodiment illustrated in FIG. 3, the entire surface of the support sheet 1 formed with the conductive pattern, except for the through-holes 31, is covered by the outer layer sheet 3, so that, even in a configuration in which the conductive pattern composed of the conductive wire is sandwiched between the support sheet 1 and the outer layer sheet 3 each composed of a wholly transparent thermoplastic resin sheet, the connection terminal section 21 can be reliably electrically connected to an external power source. Further, it becomes possible to cover and protect the heater section and the lead sections in the surface of the support sheet, by the outer layer sheet.

As need arises, an antifouling layer, an antifogging layer, an antistatic layer, a hard coat layer or the like may be formed on the surface of the outer layer sheet.

In the first aspect of the present invention, as need arises, the film heater may be configured such that a pressure-sensitive adhesive layer is provided on a surface of the support sheet on the side opposite to the surface thereof provided with the conductive pattern. By using the pressure-sensitive adhesive layer, it becomes possible to readily adhesively attach the film heater to an adherend having an uneven shape. As the pressure-sensitive adhesive layer, it is possible to use a pressure-sensitive adhesive, such as an acrylic, urethane-based, epoxy-based, rubber-based, polyester-based, cellulose-based, or emulsion pressure-sensitive adhesive.

Further, as need arises, a filler, a tackifier, a curing agent or the like may be appropriately used as an additive for improving properties of the pressure-sensitive adhesive.

The thickness of the pressure-sensitive adhesive layer is not particularly limited as long as it provides an adhesive force. It is generally set to 20 μm to 200 μm, preferably about 25 to 75 μm. When forming the pressure-sensitive adhesive layer, the pressure-sensitive adhesive may be applied using a coating method such as gravure coating, gravure reverse coating, comma coating, knife coating, or die coating.

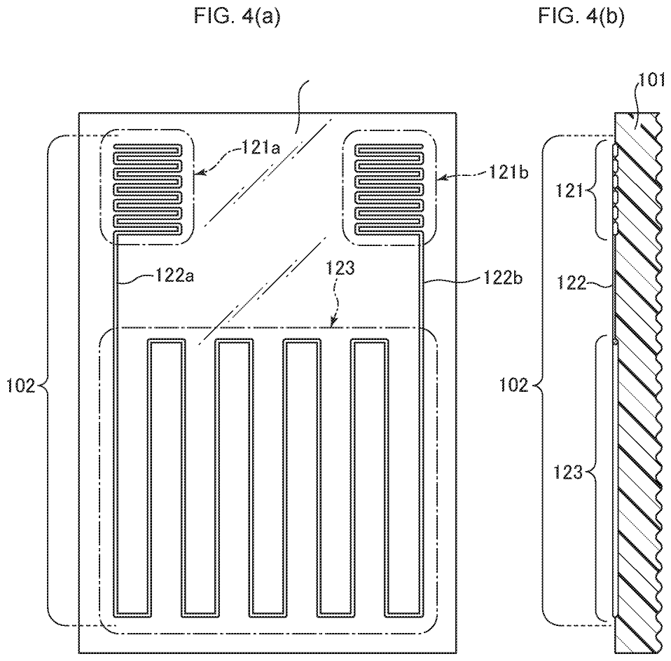

FIG. 4(a) is a top plan view schematically showing a film heater according to one embodiment of a second aspect of the present invention. FIG. 4(b) is a sectional view schematically showing the film heater according to the one embodiment of the second aspect of the present invention.

Referring to FIG. 4, a conductive pattern composed of a conductive wire is provided on one of opposite surfaces of a support sheet 101 composed of a transparent thermoplastic resin sheet. As in this embodiment, a heater section may be formed in a wholly non-straight linear shape.

In FIG. 4, the conductive pattern is formed of a continuous single conductive wire, wherein each of a pair of connection terminal sections 121a, 121b is configured as a linear pattern in which a conductive wire extending from a respective one of a pair of lead wires 122a, 122b is folded back at a plurality of positions.

The support sheet to be used in the film heater according to the second aspect of the present invention is composed of a transparent thermoplastic resin sheet. This makes it possible to suitably produce a wholly transparent film heater. Such a wholly transparent film heater can be adhesively attached to any of various adherends which are subjected to heating, without impairing aesthetic quality of the adherend.

Further, by using a thermoplastic resin sheet, it becomes possible to readily adhesively attach the film heater to an adherend even having an uneven shape. In particular, when the adherend is a resin molded body, the film heater can be formed in the surface of the resin molded body, by a molding process, such as vacuum molding, hot press molding, laminate molding, in-mold molding, or insert molding.

As the thermoplastic resin sheet, it is possible to use ethylene-based resin, propylene-based resin, polyolefin-based resin, thermoplastic polyester-based resin, polyamide-based resin, polyvinyl chloride, polycarbonate, ABS resin or the like. A mixture containing two or more of these resins may also be used. In particular, it is preferable to use polypropylene-based resin which is excellent in terms of formability (moldability), mechanical strength, flexibility, and weather resistance. It is possible to appropriately add, to the thermoplastic resin sheet, an inorganic fine powder or organic filler, a dispersant, an antioxidant, a compatibilizing agent, an ultraviolet light stabilizer, an anti-blocking agent, an antistatic agent, and the like.

The thickness of the thermoplastic resin sheet is preferably 0.030 mm to 1.000 mm, more preferably 0.100 mm to 0.700 mm.

With regard to the transparent thermoplastic resin sheet serving as the support sheet, a surface of the transparent thermoplastic resin sheet on the side opposite to the surface thereof provided with the conductive pattern composed of a conductive wire, i.e., a surface of the support sheet to be laminated to an adherend, is formed as an uneven surface. By forming the support sheet to have an uneven surface, escaping of air during lamination to the adherend becomes better, so that air bubbles causing bad external appearance and breakage or the like become less likely to be contained between the support sheet and the adherend.

Examples of a method of forming the thermoplastic resin sheet to have an uneven surface include embossing. A void space or an undulating surface based on the unevenness makes it possible to increase an actual area (surface area) per unit area of the surface of the support sheet to be laminated to an adherend, so that it is possible to improve adhesion between the adherend and the support sheet.

The level of the undulating surface based on the unevenness may be set such that the depth thereof ranges from a very small value such as several micron to a very large value such as several ten millimeter. From a viewpoint of making it difficult to see the unevenness in external appearance after lamination to the adherend, the depth is set to 5 μm to 50 μm, preferably 10 μm to 30 μm.

The shape of the unevenness is not particularly limited, but may be any geometric shape such as a wave shape, a spherical shape, a circular shape, an oval shape, a trapezoidal shape, or a cone shape, a fine satin pattern, or various other patterns. From a viewpoint of improving the escaping of air, the shape preferably includes a wave shape.

The conductive pattern can be formed by printing using conductive ink such as silver paste, or by etching of a metal foil such as copper foil. When forming the conductive pattern, it is preferable to form a cross-sectionally circular conductive wire having a constant diameter, into a given pattern, from a viewpoint of being able to easily form the heater section, the lead sections and the connection terminal sections, as a single continuous linear shape.

In a case where the conductive pattern is composed of a conductive wire, the conductive wire is preferably configured such that it comprises at least a metal wire. More preferably, the metal wire is coated with an insulating film having a self-fusing property. Although it is possible to use, as the metal wire, a wire made of metal such as copper, iron, gold, copper nickel, nickel chrome, or iron nickel chrome, any other material may also be used as long as it has a conductive property. From a viewpoint of electric resistance, durability and cost, it is preferable to use, as the metal wire, copper, or a copper alloy comprising copper, and one or a combination of two or more selected from the group consisting of zinc, lead, tin, silver, aluminum, nickel, beryllium and zirconium.

The insulating film coating the metal wire is an insulating resin film, and the conductive wire coated with the insulating film may be a commercially-available enamel wire. Specific examples of the insulating resin film may include polyester, polyethylene, polyurethane, polyvinyl chloride, polyamide, polyimide, polyester imide, polyamide imide, and fluororesin. The insulation film is typically black. However, the insulating film may be colored with any color, according to the color of an adherend which is subject to heating.

For example, the diameter of the conductive wire composing the conductive pattern is 0.03 mm to 0.20 mm. Although it is not always easy to form a thin conductive wire, the conductive wire is preferably thinned as much as possible in order to prevent impairment of aesthetic quality of an adherend which is subject to heating. Preferably, the diameter of the conductive wire is 0.05 mm to 0.15 mm. The length of the conductive wire may be set according to the pattern configuration of the conductive pattern.

The conductive pattern can be formed, typically, by laying the conductive wire on the support sheet to draw a given pattern configuration, and embedding the conductive wire at least in the surface of the support sheet to fix the conductive wire thereto.

As a method of embedding the conductive wire into the surface of the support sheet, it is desirable to embed the conductive wire in the surface of the support sheet, e.g., by utilizing the principle of ultrasonic fusing. In the ultrasonic fusing, it is possible to use a wiring drawing apparatus capable of melting the surface of the support sheet made of thermoplastic resin, while feeding out a conductive wire, and embedding the conductive wire in the surface of the support sheet. An ultrasonic head equipped in the wiring drawing apparatus is operable to apply vibration and pressure to the conductive wire which is being fed onto the surface of the support sheet, so as to cause the conductive wire to be embedded in the surface of the support sheet.

The embedding of the conductive wire into the surface of the support sheet makes it possible to perform positioning of the conductive pattern on the support sheet, thereby suppressing displacement of the conductive wire due to shock or the like from the outside. Further, by embedding the conductive wire in the surface of the support sheet, it becomes possible to reduce the level of unevenness on the surface of the support sheet caused by disposing the conductive wire on the surface of the support sheet.

Next, one embodiment of the conductive pattern of the film heater according to the second aspect of the present invention will be described.

Referring to FIG. 4, the conductive pattern 102 is configured such that a pair of right and left connection terminal sections 121a, 121b, a pair of right and left lead wires 122a, 122b each extending from a respective one of the connection terminal sections 121a, 121b, and a wholly non-straight heater section 123 continuing from the lead wires 122a, 122b, are provided as a continuous linear pattern composed of a single conductive wire. By forming the connection terminal sections, the lead wires and the heater section, using a single continuous wire, it becomes possible to simplify a production process and produce a low-cost film heater.

In FIG. 4, each of the connection terminal sections 121a, 121b is formed in a meander shape in which the conductive wire extends in a meandering manner while being folded back at a plurality of positions. In this case, each of the connection terminal sections 121a, 121b is preferably configured such that the number of times of folding-back in a folding-back region where the conductive wire is folded back at a plurality of positions in a meandering manner is increased in a given plane area to densely arrange the resulting folded-back wire portions. In the embodiment illustrated in FIG. 4, the meander shape is suitably set such that a bended portion having a relatively short length and a straight portion having a relatively long length are repeated, wherein the number of the straight portions is set to two/mm or more.

Further, as need arises, a conductive piece composed of a metal plate may be additionally provided on the connection terminal section to raise the efficiency of connection between the connection terminal section and an external electrode. As the metal plate, it is possible to use, e.g., copper, a copper alloy, iron, or an iron-nickel alloy.

In a situation where the conductive wire is coated with an insulating film, the insulating film coating the conductive wire is partly removed in a region corresponding to the the connection terminal sections, to expose the internal metal wire. A way to attain the exposure may include cutting using a milling apparatus. Alternatively, the insulating film may be melted and removed by heat during soldering connection with respect to a metal plate or external electrode.

The heater section 123 is formed by being laid from the lead wires 122a, 122b each extending from a corresponding one of the pair of right and left connection terminal sections 121a, 121b, and formed. In FIG. 4, the heater section 123 is formed as a wholly non-straight linear pattern in which a bended portion having a relatively short length and a straight portion having a relatively long length are repeated, i.e., the conductive wire extends in a meandering manner while being folded back at a plurality of positions. The pattern of the heater section may be set to any pattern, while taking into account the shape, heating area and heating efficiency of an adherent. For example, it may be repetitive of a curved shape including no straight portion, or a spiral shape.

In FIG. 4, the conductive pattern comprises the pair of right and left connection terminal sections 121a, 121b and the pair of right and left lead sections 122a, 122b, centering on the heater section 123, wherein: one 121a of the meander-shaped connection sections is formed of a conductive wire to extend from one end thereof as a starting point; one 122a of the lead wires extends from the other end of this connection section 121a; the heater section 123 is formed of a conductive film laid from this lead wire 122a; and the other lead wire 122b extends from this heater section 123 to the other connection terminal section 121b, whereby the heater section 123, the lead sections 122 and the connection terminal sections 121 are formed as a continuous linear pattern composed of a single conductive wire.

In another embodiment of the second aspect of the present invention, the film heater may be configured such that an outer layer sheet composed of an additional transparent thermoplastic resin sheet is provided on the one surface of the support sheet provided with the conductive pattern, to cover the conductive pattern, wherein the outer layer sheet is provided with two through-holes each allowing at least a part of a respective one of the connection terminal sections to be exposed to the outside.

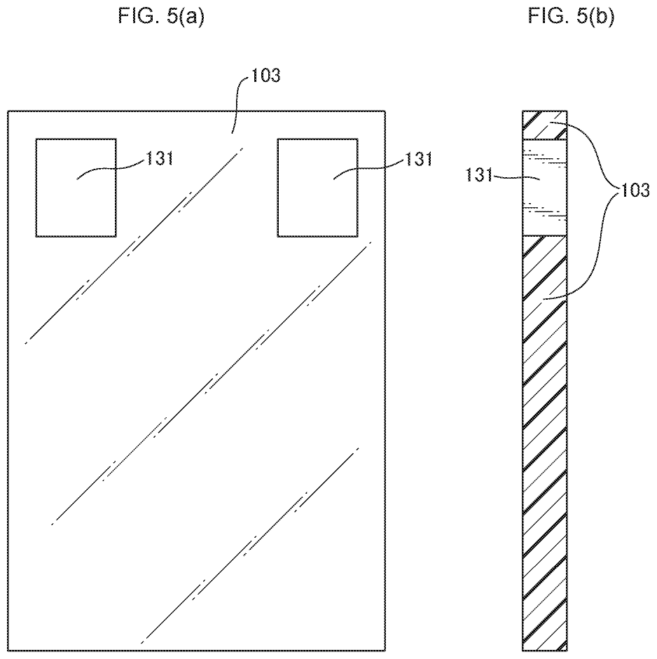

FIG. 5(a) is a top plan view schematically showing one example of an outer layer sheet usable in the second aspect of the present invention. FIG. 5(b) is a sectional view schematically showing the one example of the outer layer sheet usable in the second aspect of the present invention.

In FIG. 5, an outer layer sheet 103 having approximately the same shape as that of the support sheet of the film heater is provided with two through-holes 131 each allowing at least a part of a respective one of the connection terminal sections of the film heater to be exposed to the outside.

The outer layer sheet may be formed using a thermoplastic resin sheet similar to the support sheet. In this case, the outer layer sheet can be laminated to the surface of the support sheet formed with the conductive pattern by subjecting them to heat treatment and/or pressing. During the lamination, an adhesive layer, a pressure-sensitive adhesive layer, a heat-sealing layer or the like may be interposed between the support sheet and the outer layer sheet, as needed basis.

The outer layer sheet is provided with the through-holes each allowing at least a part of a respective one of the connection terminal sections to be exposed to the outside. The through-holes of the outer layer sheet for exposure of the connection terminal section can be formed by means of punching by a die, or cutting means such as a laser apparatus. Specifically, a Thompson blade, a cutting blade, a laser cutter, a milling apparatus or the like may be used.

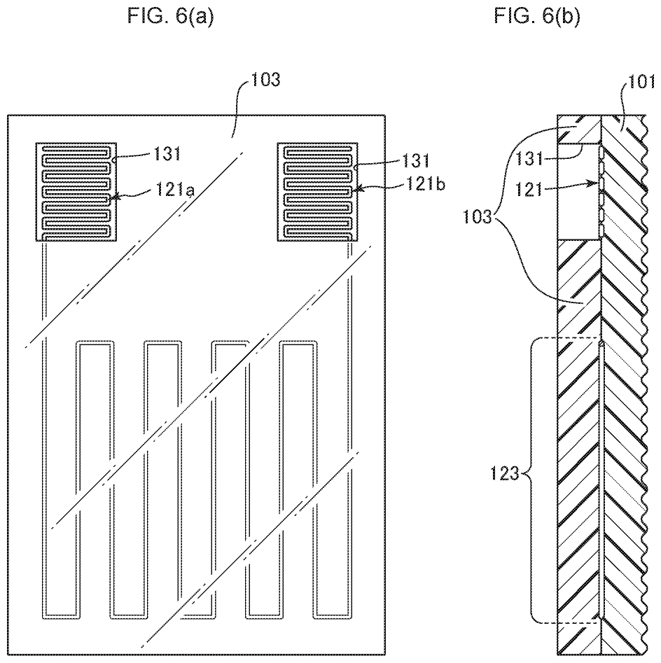

FIG. 6(a) is a top plan view schematically showing one example of the film heater according to the second aspect of the present invention, using the outer layer sheet. FIG. 6(b) is a sectional view schematically showing the one example of the film heater according to the second aspect of the present invention, using the outer layer sheet.

As can be understood from the embodiment illustrated in FIG. 6, the entire surface of the support sheet 101 formed with the conductive pattern, except for the through-holes 131, is covered by the outer layer sheet 103, so that, even in a configuration in which the conductive pattern composed of the conductive wire is sandwiched between the support sheet 101 and the outer layer sheet 103 each composed of a wholly transparent thermoplastic resin sheet, the connection terminal section 121 can be reliably electrically connected to an external power source. Further, it becomes possible to cover and protect the heater section and the lead sections in the surface of the support sheet, by the outer layer sheet.

As need arises, an antifouling layer, an antifogging layer, an antistatic layer, a hard coat layer or the like may be formed on the surface of the outer layer sheet.

In the second aspect of the present invention, as need arises, the film heater may be configured such that a pressure-sensitive adhesive layer is provided on the uneven surface of the support sheet on the side opposite to the surface thereof provided with the conductive pattern. By using the pressure-sensitive adhesive layer, it becomes possible to readily adhesively attach the film heater to an adherend. As the pressure-sensitive adhesive layer, it is possible to use a pressure-sensitive adhesive, such as an acrylic, urethane-based, epoxy-based, rubber-based, polyester-based, cellulose-based, or emulsion pressure-sensitive adhesive. Further, as need arises, a filler, a tackifier, a curing agent or the like may be appropriately used as an additive for improving properties of the pressure-sensitive adhesive.

The thickness of the pressure-sensitive adhesive layer is not particularly limited as long as it provides an adhesive force. It is generally set to 20 μm to 200 μm, preferably about 25 to 75 μm. When forming the pressure-sensitive adhesive layer, the pressure-sensitive adhesive may be applied using a coating method such as gravure coating, gravure reverse coating, comma coating, knife coating, or die coating.

### EXAMPLES

### Example 1

A thermoplastic resin sheet (Polyca Sheet DPI-AO, manufactured by Mitsubishi Plastics, Inc., thickness: 0.075 mm) serving as a support sheet was prepared, and a conductive wire (self-fusing film-coated conductive wire AB15 φ 0.10 mm, manufactured by ELEKTRISOLA) was embedded in the surface of the support sheet, using a wiring drawing apparatus (WCE150, manufactured by Ruhlamat, setting conditions: USP1200, speed 40%) equipped with an ultrasonic head, to form a conductive pattern as shown in FIG. 1.

The conductive pattern was formed such that: each lead section (a straight portion from each connection terminal section to a first folded-back position) had a length of 130 mm; a heater section had a straight portion having a length of 90 mm, and a folding-back portion having a pitch of 10 mm, wherein the number of times of folding-back (the number of the straight portions) was 8; and each connection terminal section had a straight portion having a length of 17 mm, and a folding-back portion having a pitch of 0.3 mm, wherein the number of times of folding-back (the number of the straight portions) was 12. Last of all, the resulting support sheet was cut into a size of 170 mm length×120 mm width to produce a film heater.

### Example 2

A thermoplastic resin sheet (Polyca Sheet DPI-AO, manufactured by Mitsubishi Plastics, Inc., thickness: 0.075 mm) serving as an outer layer sheet was prepared, and two through-holes each having a size of 10 mm length×10 mm were formed at respective positions corresponding to the connection terminal sections. The outer layer sheet was placed on the surface of the support sheet in which the conductive pattern was wired, and subjected to hot press, using a vacuum laminating machine (MVLP-500, manufactured by MEIKI CO., LTD, temperature: 180° C., pressure: 0.5 MPa), so that it was sufficiently firmly attached to the support sheet. Last of all, the resulting laminate was cut into a size of 170 mm length×120 mm width to produce a film heater.

### Example 3

A thermoplastic resin sheet (Polyca Sheet DPI-AO, manufactured by Mitsubishi Plastics, Inc., thickness: 0.075 mm) serving as a support sheet was prepared, and sandwiched between a metal plate having a flat surface and a metal plate having a surface formed to serve as an embossing die. Then, the support sheet was subjected to hot press, using a vacuum laminating machine (MVLP-500, manufactured by MEIKI CO., LTD, temperature: 180° C., pressure: 0.5 MPa), to perform embossing, thereby form one surface of the support sheet as an uneven surface. The uneven surface was formed in a continuous wave pattern having a depth of 20 μm.

A conductive wire (self-fusing film-coated conductive wire AB15 φ 0.10 mm, manufactured by ELEKTRISOLA) was embedded in the flat surface of the support sheet, using a wiring drawing apparatus (WCE150, manufactured by Ruhlamat, setting conditions: USP1200, speed 40%) equipped with an ultrasonic head, to form a conductive pattern as shown in FIG. 4.

The conductive pattern was formed such that: each lead section (a straight portion from each connection terminal section to a first folded-back position) had a length of 130 mm; a heater section had a straight portion having a length of 90 mm, and a folding-back portion having a pitch of 10 mm, wherein the number of times of folding-back (the number of the straight portions) was 8; and each connection terminal section had a straight portion having a length of 17 mm, and a folding-back portion having a pitch of 0.3 mm, wherein the number of times of folding-back (the number of the straight portions) was 12. Last of all, the resulting support sheet was cut into a size of 170 mm length×120 mm width to produce a film heater.

### Example 4

A thermoplastic resin sheet (Polyca Sheet DPI-AO, manufactured by Mitsubishi Plastics, Inc., thickness: 0.075 mm) serving as an outer layer sheet was prepared, and two through-holes each having a size of 10 mm length×10 mm were formed at respective positions corresponding to two connection terminal sections. The outer layer sheet was placed on the surface of the support sheet in which the conductive pattern was wired, in Example 3, and subjected to hot press, using a vacuum laminating machine (MVLP-500, manufactured by MEIKI CO., LTD, temperature: 180° C., pressure: 0.5 MPa), so that it was sufficiently firmly attached to the support sheet. Last of all, the resulting laminate was cut into a size of 170 mm length×120 mm width to produce a film heater.

### LIST OF REFERENCE SIGNS

1, 101: support sheet
2, 102: conductive pattern
21a, 21b, 121a, 121b: connection terminal section
22a, 22b, 122a, 122b: lead section
23, 123: heater section
3, 103: outer layer sheet
31: 131: through-hole

1. A film heater comprising a conductive pattern composed of a conductive wire, the conductive pattern is provided on one surface of a support sheet composed of a transparent thermoplastic resin sheet, wherein the conductive pattern is configured such that a connection terminal section, a lead wire extending from the connection terminal section and a heater section continuing from the lead wire are provided as a continuous linear pattern composed of a single conductive wire.

2. The film heater as recited in claim 1, wherein the connection terminal section is configured to have a pattern in which the conductive wire is folded back at a plurality of positions.

3. The film heater as recited in claim 1, wherein an outer layer sheet composed of a transparent thermoplastic resin sheet other than the support sheet is provided on the surface of the support sheet provided with the conductive pattern, to cover the conductive pattern, wherein the outer layer sheet is provided with a through-hole which allows at least a part of the connection terminal section to be exposed to outside.

4. The film heater as recited in claim 1, wherein a metal plate is further provided on the connection terminal section.

5. The film heater as recited in, wherein the conductive wire composing the conductive pattern, except for the connection terminal section, is coated with an insulating film having a self-fusing property.

6. The film heater as recited in claim 1, wherein a pressure-sensitive adhesive layer is provided on a surface of the support sheet on a side opposite to the surface provided with the conductive pattern.

7. A film heater comprising a conductive pattern composed of a conductive wire, the conductive pattern is provided on one of opposite surfaces of a support sheet composed of a transparent thermoplastic resin sheet, wherein the other surface of the support sheet has unevenness, and the conductive pattern comprises a connection terminal section, a lead wire extending from the connection terminal section, and a heater section continuing from the lead wire.

8. The film heater as recited in claim 7, wherein the conductive pattern is formed of a continuous single conductive wire.

9. The film heater as recited in claim 7, wherein the connection terminal section is configured to have a pattern in which the conductive wire extending from the lead section is folded back at a plurality of positions.

10. The film heater as recited in claim 7, wherein an outer layer sheet composed of a transparent thermoplastic resin sheet other than the support sheet is provided on the one surface of the support sheet, to cover the conductive pattern, wherein the outer layer sheet is provided with a through-hole which allows at least a part of the connection terminal section to be exposed to outside.

11. The film heater as recited in claim 7, wherein a metal plate is further provided on the connection terminal section,

12. The film heater as recited in claim 1, wherein the conductive wire composing the conductive pattern, except for the connection terminal section, is coated with an insulating film having a self-fusing property.

13. The film heater as recited in claim 1, wherein a pressure-sensitive adhesive layer is provided on the other surface of the support sheet.
